(19) United States
(12) Patent Application Publication
(10) Pub. No.: US 2024/0385489 A1
(43) Pub. Date: Nov. 21, 2024

(54) DISPLAY DEVICE

(71) Applicant: E Ink Holdings Inc., Hsinchu (TW)

(72) Inventor: Chien-Hsing Chang, Hsinchu (TW)

(73) Assignee: E Ink Holdings Inc., Hsinchu (TW)

(21) Appl. No.: 18/597,780

(22) Filed: Mar. 6, 2024

(30) Foreign Application Priority Data
May 17, 2023 (TW) 112118245

(51) Int. Cl. G02F 1/1677; G02F 1/167; G06F 3/044

(52) U.S. Cl. CPC G02F 1/1677; G02F 1/167; G06F 3/0446

(57) ABSTRACT

Disclosed is a display device including a display panel, a plurality of color blocks with different colors, a touch panel, and at least one birefringent material layer. The color blocks with different colors are distributed on the display panel. The touch panel is disposed on the color blocks with different colors. The birefringent material layer is disposed between the color blocks with different colors and the touch panel. After passing through the birefringent material layer, a light from the color blocks with different colors is divided into an ordinary light and an extraordinary light laterally shifted by a distance from the ordinary light.

### CROSS-REFERENCE TO RELATED APPLICATION

This application claims the priority benefit of Taiwan application serial no. 112118245, filed on May 17, 2023. The entirety of the above-mentioned patent application is hereby incorporated by reference herein and made a part of this specification.

### BACKGROUND

### Technical Field

The present disclosure relates to a display device.

### Description of Related Art

As display technology continues to improve, display devices (such as electrophoretic display device) are developed. Electrophoretic display devices produce different gray scales by moving electrophoretic particles of different colors (such as black, white or other colors) to the top or bottom of a capsule. In addition, electrophoretic display device adopts electrophoretic particles to reflect light to achieve image display. Therefore, it is not necessary to use light source modules to illuminate electrophoretic particles. Instead, ambient light may be adopted to illuminate electrophoretic particles to achieve display effects. Therefore, more power may be saved. In addition, the electrophoretic particles can still be displayed normally after the voltage applied to the electrodes is removed. By utilizing this feature, the electrophoretic display device is able to save more power.

For a display device (such as an electrophoretic display device) to display a colored frame, one method is to print color blocks of different colors on the display panel to achieve a color display effect. Since fixed and equidistant color blocks are produced during printing, for example, when there is a touch panel using a metal grid on the top of the display, the metal grid has light-shielding properties when in use, accordingly there will be optical interference between the metal grid and the color blocks printed in color, and a moiré effect will be generated, which significantly affects the display quality of the display device.

### SUMMARY

The present disclosure provides a display device, which may effectively suppress the moiré effect.

An embodiment of the disclosure provides a display device, which includes a display panel, a plurality of color blocks with different colors, a touch panel, and at least one birefringent material layer. The color blocks with different colors are distributed on a display panel. The touch panel is disposed on the color blocks with different colors. The birefringent material layer is disposed between the color blocks with different colors and the touch panel. After passing through the birefringent material layer, a light from the color blocks with different colors is divided into an ordinary light and an extraordinary light laterally shifted by a distance from the ordinary light.

In the display device in an embodiment of the present disclosure, since the birefringent material layer is adopted to divide the light from the color blocks of multiple different colors into ordinary light and extraordinary light, it is possible to scatter the light from the color blocks and destroy the original regularity between the color blocks and the structure of the touch panel. In this way, the moiré effect caused by the regularity between the color blocks and the structure of the touch panel may be effectively suppressed.

### BRIEF DESCRIPTION OF THE DRAWINGS

FIG. 1 is a schematic partial cross-sectional view of a display device according to an embodiment of the present disclosure.

FIG. 2 is a schematic partial cross-sectional view of a display device according to another embodiment of the present disclosure.

### DESCRIPTION OF THE EMBODIMENTS

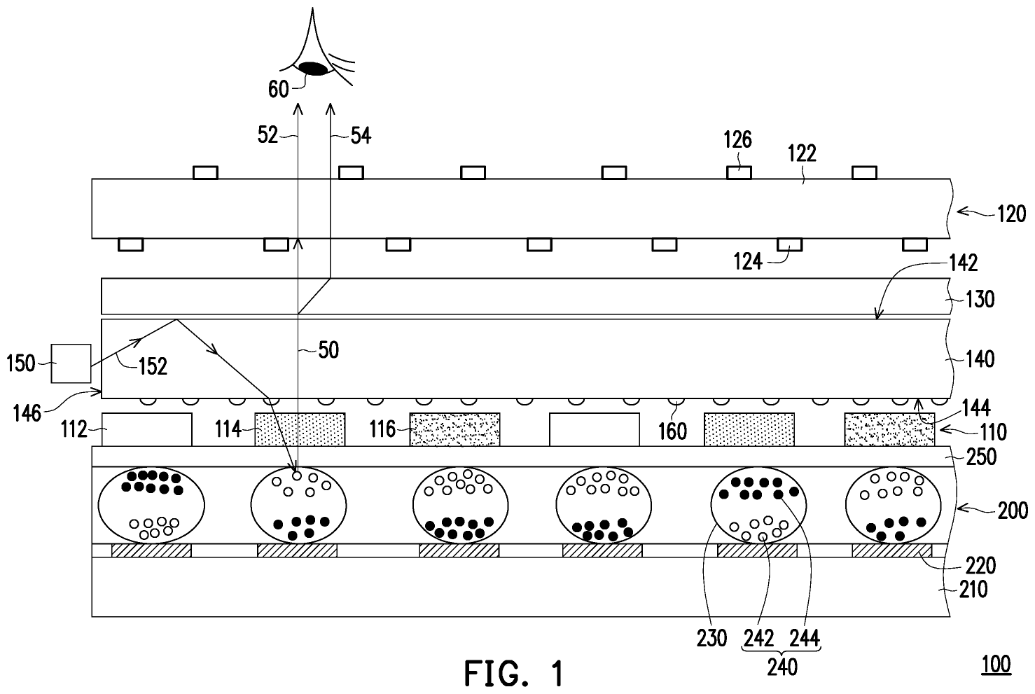

FIG. 1 is a schematic partial cross-sectional view of a display device according to an embodiment of the present disclosure. Please refer to FIG. 1, the display device 100 of the present embodiment includes a display panel 200, a plurality of color blocks 110 of different colors, a touch panel 120 and at least one birefringent material layer 130 (FIG. 1 shows one birefringent material layer 130 as an example). In this embodiment, the display panel 200 includes a substrate 210, a first electrode layer 220, a plurality of capsules 230, a plurality of electrophoretic particles 240 and a second electrode layer 250. The first electrode layer 220 is disposed on the substrate 210, and the capsule 230 is disposed between the first electrode layer 220 and the second electrode layer 250. The capsule 230 contains electrophoretic particles 240. Electrophoretic particles 240 include a variety of electrophoretic particles of different colors, such as white electrophoretic particles 242 and black electrophoretic particles 244, which vary with the voltage change of the first electrode layer 220 and the second electrode layer 250 and float in the liquid filled in the capsule. Moreover, the display panel 200 is, for example, an electrophoretic display panel, also known as an electronic paper display panel or an electronic ink display panel, and the display device 100 is, for example, an electrophoretic display device, but the present disclosure is not limited thereto. For example, in other embodiments, the display panel 200 may also be a liquid crystal display panel, and the display device 100 is, for example, a liquid crystal display.

Multiple color blocks 110 of different colors are distributed on the display panel 200. In this embodiment, the color blocks 110 of different colors include a plurality of red color blocks 112, a plurality of green color blocks 114, and a plurality of blue color blocks 116 arranged alternately, which may be combined with the capsule 230 to form a plurality of sub-pixels of different colors. In this embodiment, the color blocks 110 are formed by jet printing pigments. In other embodiments, the color blocks 110 of different colors may also be color blocks of other colors, such as yellow color blocks, magenta color blocks, cyan color blocks or other appropriate color blocks.

The touch panel 120 is disposed on the color blocks 110 of various colors. In this embodiment, there are metal grids 124 and 126 on the surface of the touch panel 120. For example, the touch panel 120 may include a transparent substrate 122 and metal grids 126 and 124 disposed on the upper and lower surfaces of the transparent substrate 122.

The birefringent material layer 130 is disposed between the color blocks 110 of different colors and the touch panel 120. After passing through the birefringent material layer 130, the light 50 from the color blocks 110 of the different colors is divided into ordinary light 52 and extraordinary light 54 laterally shifted by a distance from the ordinary light 52. The ordinary light 52 and the extraordinary light 54 have different polarization directions, for example, the polarization direction of the ordinary light 52 is perpendicular to the polarization direction of the extraordinary light 54. In addition, in this embodiment, after passing through the birefringent material layer 130, the extraordinary light 54 is laterally shifted by a distance from the ordinary light 52, and the extraordinary light 54 is parallel to the ordinary light 52. The birefringent material layer 130 may also be called a phase difference plate, which has different refractive indices in at least two different directions, so that light rays with different polarization directions travel at different speeds therein, resulting in a phase difference.

In the display device 100 of this embodiment, since the birefringent material layer 130 is adopted to divide the light 50 from the color blocks 110 of different colors into the ordinary light 52 and the extraordinary light 54, it is possible to scatter the light 50 from the color blocks 110 and destroy the original regularity between the color blocks 110 and the structure of the touch panel 120 (e.g., metal grids 124 and 126). In this way, the moiré effect caused by the regularity between the color blocks 110 and the structure of the touch panel 120 (e.g., metal grids 124 and 126) may be effectively suppressed.

In the present embodiment, the phase difference of the birefringent material layer 130 is greater than 15 nanometers, so the extraordinary light 54 may have a sufficient laterally shifting distance from the ordinary light 52, and then the light 50 from the color blocks 110 may be effectively scattered.

In this embodiment, the display device 100 further includes a light guide plate 140 disposed between the color blocks 110 of different colors and the birefringent material layer 130. Moreover, in this embodiment, the display device 100 further includes a light source 150, and the light guide plate 140 has a first surface 142 facing the birefringent material layer 130, and a second surface 144 facing the color blocks 110 of different colors, as well as a light incident surface 146 connecting the first surface 142 and the second surface 144. Furthermore, the light source 150 is disposed beside the light incident surface 146 and emits light toward the light incident surface 146. In this embodiment, the light source 150 emits an illuminating beam 152. After entering the light guide plate 140 from the light incident surface 146, the illuminating beam 152 is continuously totally reflected by the first surface 142 and the second surface 144, and is transmitted in the light guide plate 140. At least one of the first surface 142 and the second surface 144 may be provided with an optical microstructure 160, the optical microstructure 160 may destroy the total reflection, so that the illumination beam 152 passes through the second surface 144 downwards and irradiates the color block 110 and the electrophoretic particles 240, or make the illumination beam 152 penetrate upwards through the first surface 142 to form stray light. The white electrophoretic particles 242 may reflect the illumination beam 152 into the light 50, so that the light 50 passes through the color blocks 110 and the light guide plate 140 upwards to be transmitted to the birefringent material layer 130. Alternatively, in another embodiment, the display device 100 may not have the light guide plate 140 and the light source 150, and the white electrophoretic particles 242 may reflect ambient light into the light 50. The birefringence material layer 130 divides the light 50 into ordinary light 52 and extraordinary light 54, and the ordinary light 52 and the extraordinary light 54 pass through the touch panel 120 and are transmitted to the user's eyes 60. In this way, the user is able to watch the image frame displayed by the electrophoretic particles 240, and the moiré effect of the image frame may be effectively suppressed.

In this embodiment, the display panel 200 is provided with a second electrode layer 250 on one side close to the touch panel 120, and the color blocks 110 of various colors directly contact the second electrode layer 250. The birefringent material layer 130 is disposed between the touch panel 120 and the light guide plate 140. In an embodiment, the birefringent material layer 130 directly contacts the light guide plate 140. However, in other embodiments, there may be air gaps or other films between the birefringent material layer 130 and the light guide plate 140. In an embodiment, the birefringent material layer 130 directly contacts the touch panel 120, however, in other embodiments, there may be air gaps or other films between the birefringent material layer 130 and the touch panel 120.

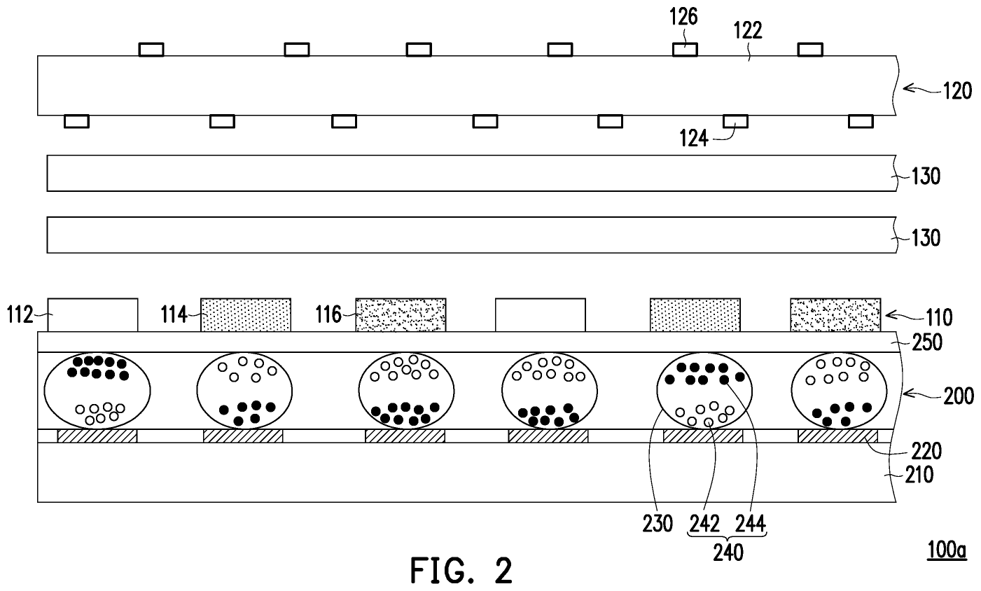

FIG. 2 is a schematic partial cross-sectional view of a display device according to another embodiment of the present disclosure. Referring to FIG. 2, the display device 100a of this embodiment is similar to the display device 100 of FIG. 1, and the main differences between the two are as follows. The display device 100a of this embodiment includes a plurality of birefringent material layers 130 stacked from the color blocks 110 of different colors to the touch panel 120 (two birefringent material layers 130 are shown as an example in FIG. 2). The use of multiple birefringent material layers 130 allow the light from the color blocks 110 to scatter more, and further destroy the original regularity between the color blocks 110 and the metal grids 124 and 126, thereby suppressing the moiré effect more effectively.

To sum up, in the display device in the embodiments of the present disclosure, because the birefringent material layer is adopted to divide the light from the color blocks of multiple different colors into ordinary light and extraordinary light, it is possible to scatter the light from the color blocks and destroy the original regularity between the color blocks and the structure of the touch panel. In this way, the moiré effect caused by the regularity between the color blocks and the structure of the touch panel may be effectively suppressed.

What is claimed is:

1. A display device, comprising:
a display panel;
a plurality of color blocks with different colors, distributed on the display panel;
a touch panel, disposed on the color blocks with different colors; and
at least one birefringent material layer, disposed between the color blocks with different colors and the touch panel, wherein after passing through the birefringent material layer, a light from the color blocks with different colors is divided into an ordinary light and an extraordinary light laterally shifted by a distance from the ordinary light.

2. The display device according to claim 1, wherein a phase difference of the birefringent material layer is greater than 15 nanometers.

3. The display device according to claim 1, further comprising a light guide plate disposed between the color blocks of different colors and the birefringent material layer.

4. The display device according claim 3, further comprising a light source, wherein the light guide plate has a first surface facing the birefringent material layer, and a second surface facing the color blocks of different colors, as well as a light incident surface connecting the first surface and the second surface, and the light source is disposed beside the light incident surface and emits a light toward the light incident surface.

5. The display device according to claim 1, wherein there are metal grids on a surface of the touch panel.

6. The display device according to claim 1, wherein the color blocks of different colors comprise a plurality of red color blocks, a plurality of green color blocks, and a plurality of blue color blocks arranged alternately.

7. The display device according to claim 1, wherein the at least one birefringent material layer is a plurality of birefringent material layers stacked from the color blocks of different colors to the touch panel.

8. The display device according to claim 1, wherein the display panel is provided with an electrode layer on one side close to the touch panel, and the color blocks of different colors directly contact the electrode layer.

9. The display device according to claim 3, wherein the birefringent material layer is disposed between the touch panel and the light guide plate, and directly contacts the light guide plate.

10. The display device according to claim 9, wherein the birefringent material layer directly contacts the touch panel.
